(19) United States
(12) Patent Application Publication
(10) Pub. No.: US 2010/0062113 A1
(43) Pub. Date: Mar. 11, 2010

(54) HYDROGEN-DISSOLVED AQUEOUS SOLUTION AND METHOD FOR PROLONGING THE LIFE DURATION OF HYDROGEN DISSOLVED IN THE AQUEOUS SOLUTION

(76) Inventor: Osao Sumita, Tokyo (JP)

Correspondence Address: JORDAN AND HAMBURG LLP, 122 EAST 42ND STREET, SUITE 4000, NEW YORK, NY, 10168, US

(21) Appl. No.: 12/312,702

(22) PCT Filed: Nov. 21, 2007
(86) PCT No.: PCT/JP2007/072510

§ 371 Date: May 21, 2009

(30) Foreign Application Priority Data
Nov. 24, 2006 (JP) 2006-317636

(51) Int. Cl. A23L 2/00

(52) U.S. Cl. 426/67

(57) ABSTRACT

Provided is an aqueous solution in which hydrogen dissolved therein has a long life duration at low cost. Specifically disclosed is an aqueous solution having hydrogen dissolved therein at a concentration of not less than 0.01 ppm and not higher than the saturated concentration, wherein the aqueous solution contains a substance having a reducing aldehyde group and/or a glycoside hydroxyl group in an amount of 10 to 300000 ppm.

### APPLICABLE FIELD IN THE INDUSTRY

The present invention relates to a hydrogen-dissolved aqueous solution that is said to be good for health.

### BACKGROUND ART

Recently, a lot of documents associated with efficacy of hydrogen have been issued. For example, in Hidemitsu Hayashi “Hydrogen Rich Water Cures Cancer”, or the like, it is reported that dissolved hydrogen is helpful in improving a human body. In addition hereto, effects such as a fall of a blood pressure and a fall of a blood sugar value have been reported.

By the way, the following methods exist as a method of taking hydrogen in.

(1) A method of inserting metal such as magnesium in water, and utilizing hydrogen gas (a hydrogen molecule) that is generated with a progress in localized corrosion of the metal.

(2) A method of subjecting water to cathodic electrolysis, thereby to directly dissolve hydrogen in the water.

(3) A method of dissolving hydrogen gas coming from a hydrogen steel cylinder in water.

As it is, it is difficult to keep a concentration of hydrogen dissolved in an aqueous solution for a long time. That is, life duration of dissolved hydrogen (hydrogen dissolved in water) is, as a rule, short.

### DISCLOSURE OF THE INVENTION

### Problems to be Solved by the Invention

By the way, as mentioned above, the aqueous solution having hydrogen dissolved therein (hydrogen-dissolved aqueous solution) is said to be good for health.

As it is, so as to merchandise the hydrogen-dissolved aqueous solution as health food, it is essential that life duration of dissolved hydrogen is long.

The reason is that to drink the hydrogen-dissolved aqueous solution is nothing but to drink aqueous solution having no hydrogen dissolved in many cases when life duration of the dissolved hydrogen is short. As a result, it causes a reliability of a product to be lost.

Accordingly, the present invention has been accomplished so as to solve the above-mentioned problems, and an object thereof is to provide the aqueous solution in which hydrogen dissolved therein has long life duration at a low cost.

### Means for Solving the Problem

By the way, an oxidation-reduction potential (ORP) is thinkable as an index for investigating life duration of the dissolved hydrogen. Namely, reviewing the oxidation-reduction potential (ORP) of the hydrogen-dissolved aqueous solution demonstrated that the ORP had a relation to a concentration of the dissolved hydrogen. For example, as a concentration of the dissolved hydrogen increases, a value of the ORP becomes a minus value. Contrarily, as a concentration of the dissolved hydrogen approaches zero, a value of the ORP becomes a plus value.

Thereupon, this inventor added various additives to the hydrogen-dissolved aqueous solution, and measured the ORP. As a result, the inventor found out that a value of the ORP was kept in a situation of being minus when a certain cell-extract solution was employed as an additive.

And, as a result of having earnestly promoted a furthermore development and study, it has been known that adding a substance (compound) having an aldehyde group (CHO group) or a glycosidic hydroxyl group (OH group) prolongs life duration of the dissolved hydrogen.

Additionally, it has been known that adding a substance (compound) having a phenolic hydroxyl group also prolongs life duration of the dissolved hydrogen even though an effect of extending life duration of the dissolved hydrogen declines to some extent as compared with the case of adding a substance (compound) having a glycosidic hydroxyl group (OH group).

Further, it has been known that adding a substance (compound) having an alcoholic hydroxyl group (OH group) also prolongs life duration of the dissolved hydrogen even though an effect of extending life duration of the dissolved hydrogen declines to some extent as compared with the case of adding a substance (compound) having a phenolic hydroxyl group.

And, the inventor has investigated the reason why adding these substances (compounds) having an aldehyde group (CHO group), a glycosidic hydroxyl group, a phenolic hydroxyl group, and an alcoholic hydroxyl group (OH group) prolongs life duration of the dissolved hydrogen. As a result, the inventor has come to the following conclusion. That is, migration of electric charge between an oxygen atom and a hydrogen atom occurs partially in these groups (CHO group and OH group), and resultantly, a polarization occurs. And, it is thought that a large polarization causes a hydrogen atom to be dissociated. Namely, the compounds having these groups have a high ability of supplying the hydrogen atom and a high reducing ability. The inventor has come to a conclusion that its fact could prolong life duration of the dissolved hydrogen.

For example, the compound having a phenolic hydroxyl group is thought to be compound as described below.

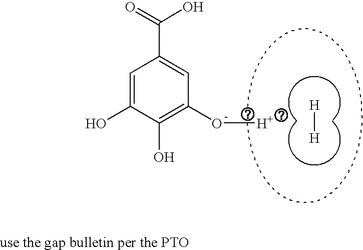

That is, the electric charge biased between the oxygen atom and the hydrogen atom exists. In other words, the oxygen atom is inclined to be minus-charged, and the hydrogen atom to be plus-charged due to a difference of an electronegativity. And, the hydrogen atom is dissociated (the hydrogen atom is supplied), and reducing power is increased because the electric charge largely biased between the oxygen atom and the hydrogen atom exists. As it is, it is thought that a hydrogen molecule has two electronic clouds around two hydrogen atoms. Namely, the hydrogen molecule is microscopically polarized into a plus-charged hydrogen atom existing at a center and a minus-charged electron existing in the circumference. Thus, when a plus-charged field exists in water, the hydrogen molecule is stabilized. Upon simplifying the matter, it seems that a plus-charged ion such as a metal ion (for example, Na⁺) existing in an aqueous solution is effective in stabilizing the hydrogen molecule. However, the metal ion, as a rule, has been hydrated, and a hydrated molecule disturbs a metal ion-hydrogen molecule interaction. Thus, an effect of extending life duration of the dissolved hydrogen of the aqueous solution was not recognized even though the metal ion was added. Rather, it was thought that the reason why an effect of extending life duration of the dissolved hydrogen was recognized was that no hydrated molecule existed in the hydrogen ion. And, it was thought that an interaction between the plus-charged hydrogen atom (hydrogen atom of the hydroxyl-group hydrogen atom) and the hydrogen molecule stabilized the hydrogen molecule, thereby prolonging life duration of the dissolved hydrogen concentration. Additionally, when a concentration of the dissolved hydrogen is high, a concentration of the hydroxyl group as well has to be raised correspondently. And, it is thought that extending life duration of the dissolved hydrogen concentration all the more necessitates the hydrogen ion having a higher concentration. However, the aqueous solution having a higher-concentration hydrogen ion is not suitable for eating and drinking because it assumes a strong acid. Therefore, it is not preferable to raise the hydrogen ion concentration. On the other hand, employing a phenolic hydroxyl group makes it possible to raise the hydroxyl group concentration without intensifying acidity so that much. Thus, it is preferable to use the compound having a phenolic hydroxyl group for eating and drinking.

By the way, adding the compound having an alcoholic hydroxyl group also prolongs life duration of the dissolved hydrogen concentration similarly to the case of adding the compound having a phenolic hydroxyl group.

However, a polarization degree of the hydrogen atom in the alcoholic hydroxyl group is smaller than that of the hydrogen atom in the phenolic hydroxyl group. And, an extent of an interaction between the hydrogen atom of the alcoholic hydroxyl group and the hydrogen molecule is small. It seems that this affects the fact that life duration of the dissolved hydrogen concentration in the case of adding the compound having an alcoholic hydroxyl group is shorter as compared with the case of adding the compound having a phenolic hydroxyl group.

On the other hand, life duration of the dissolved hydrogen concentration in the case of adding the compound having a glycosidic hydroxyl group is longer than that in the case of adding the compound having a phenolic hydroxyl group.

The following is thought as a primary factor. That is, the electric charge largely biased between the oxygen atom and the hydrogen atom exists in the glycosidic hydroxyl group. And, the hydrogen atom coupled to the oxygen atom has a tendency of being easily dissociated. Namely, it is thought that an ability of supplying the hydrogen atom is high. Upon exemplifying α-glucose for explanation, the following is yielded. That is, as illustrated in the following reaction mechanism of α-glucose, it is thought that the hydrogen atom of the glycosidic hydroxyl group of the α-glucose is dissociated, and this dissociated hydrogen atom and the dissolved hydrogen form a complex, thereby prolonging life duration of the dissolved hydrogen. Namely, the electron migrates from the hydrogen atom to the α-glucose. And, the hydrogen ion forms a complex with the hydrogen molecule. It is thought that life duration in water is prolonged because, as a result thereof, the hydrogen molecule has the electric charge.

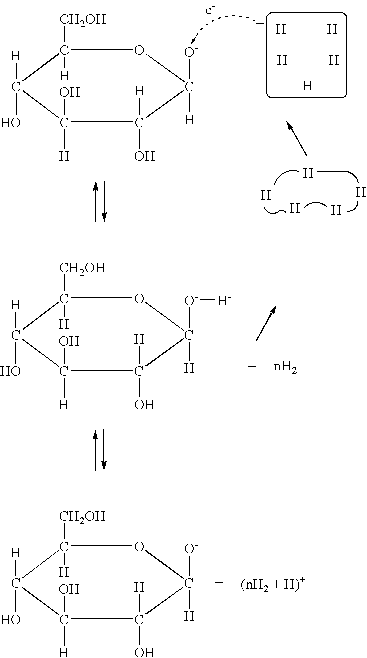

It is thought that this fact is applied likewise not only in the case of the hydroxyl group (OH group) but also in the case of the aldehyde group (CHO group).

That is, also in the case that the compound having an aldehyde group has been added, a complex is formed between the hydrogen atom (hydrogen ion) dissociated from such a compound and the hydrogen molecule. As a result, stability of the dissociated hydrogen in water is enhanced, thereby prolonging life duration of the hydrogen molecule.

The present invention has been accomplished based upon the above-mentioned knowledge.

That is, the foregoing problem is solved by an aqueous solution having hydrogen dissolved therein at a concentration of not less than 0.01 ppm and yet not higher than a saturated concentration, wherein a substance having a reducing aldehyde group and/or a hydroxyl group (the hydroxyl group is a glycosidic hydroxyl group, a phenolic hydroxyl group, or an alcoholic hydroxyl group. They are enumerated in a descending order of the effect, to begin with the first one) is added to the aqueous solution, and wherein a contained amount of the above substance is a ratio of 10 to 300,000 ppm.

The foregoing problem is solved by a method for prolonging life duration of dissolved hydrogen in an aqueous solution having hydrogen dissolved therein at a concentration of not less than 0.01 ppm and yet not higher than a saturated concentration, wherein a substance having a reducing aldehyde group and/or a hydroxyl group (the hydroxyl group is a glycosidic hydroxyl group, a phenolic hydroxyl group, or an alcoholic hydroxyl group. They are enumerated in a descending order of the effect, to begin with the first one) is added to the aqueous solution at a ratio of 10 to 300,000 ppm.

The foregoing problem is solved by a method for producing drinking water having hydrogen dissolved therein at a concentration of not less than 0.01 ppm and yet not higher than a saturated concentration, wherein a substance having a reducing aldehyde group and/or a hydroxyl group (the hydroxyl group is a glycosidic hydroxyl group, a phenolic hydroxyl group, or an alcoholic hydroxyl group. They are enumerated in a descending order of the effect, to begin with the first one) is added at a ratio of 10 to 300,000 ppm.

Additionally, when the hydrogen concentration is higher, the hydrogen effect is exhibited all the more. The lower-limit value of the hydrogen concentration at which the hydrogen effect is exhibited is 0.01 ppm. However, preferably, it is 0.05 ppm or more. More preferably, it is 0.1 ppm or more. In particular, it is 0.3 ppm or more.

The lower-limit value of an addition amount of the substance having a reducing aldehyde group and/or a hydroxyl group that is added for prolonging life duration of the dissolved hydrogen (hereinafter, referred to as this substance in some case or this compound in some cases) is 10 ppm. However, preferably, it is 50 ppm or more. More preferably, it is 100 ppm or more. While no special restrain to the upper-limit value is put, 300,000 ppm is defined as an upper-limit value. However, as matters now stand, it is 150,000 ppm or so. Needless to say, the value exceeding this does not matter; however, it is 150,000 ppm or so from a viewpoint of a cost.

This substance (this compound) is a cell-extract. Specifically, it is a cell-extract that is extracted, for example, from the tea such as green tea, barley tea, black tea, oolong tea, eucommia ulmoides tea, seaweed drink, and hub tea. Or, it is a cell-extract that is extracted from honey, yeast extract, ginseng, panax ginseng, maca, honey sugar, agaricus, aloe, garlic, etc. Or, it is a cell-extract that is extracted from fruit or vegetable. For example, it is juice (squeezed juice) of orange, grape fruit, grape, pineapple, mango, tomato, melon, ume, carrot, tomato, red pepper, green pepper, celery, cabbage, spinach, pumpkin, onion, etc.

The above-mentioned cell-extract is, for example, saccharides, and salts thereof. Upon explaining it more specifically, it is monosaccharides, disaccharides, oligosaccharides, polysaccharides, sugar alcohol, etc. As monosaccharides, for example, there can be listed glucose, galactose, mannose, fructose, ribose, allose, gulose, xylose, arabinose, lyxose, idose, talose, etc. As disaccharides, for example, there can be listed maltose, lactose, cellobiose, fructose, etc. As oligosaccharides, for example, there can be listed oligosaccharide, etc. As polysaccharides, for example, there can be listed chitin, chitosan, starch, cellulose, carrageenan, glycogen, pectin, dextrin, xyloglucan, gelatin, hyaluronic acid, alginic acid, etc. Further, Na-salts and K-salts of the foregoing compounds are also employed. Additionally, the monosaccharide, of which a molecular weight is smaller, is more preferable than the polysaccharides. The reason is that a concentration of the reducing reactive group is high.

The above-mentioned cell-extract is, for example, polyphenol. Upon explaining it more specifically, there can be listed, for example, flavonoid (catechin, anthocyanin, tannin, rutin, isoflavone, etc.), anthocyanin, phenolic acid (chlorogenic acid, ellagic acid, lignan, curcumin, coumarin, etc.), ellagic acid, lignan, curcumin, coumarin, etc.

The present invention is an invention containing at least the substance having a reducing aldehyde group and/or a hydroxyl group. Preferably, vitamin (for example, vitamin A, a vitamin B group, vitamin C, vitamin D, and vitamin E) is added additionally. Further, coenzyme (for example, vitamin B2, niacin, vitamin C, vitamin E, ubiquinone, ubiquinol, pyrroloquinoline quinone, etc.) is added. That is, adding these additives additionally accelerates dissociation of H, thereby prolonging life duration the dissolved hydrogen.

In particular, the component of which the hydrogen atom is easily dissociated, or the substance (for example, the substance belonging to a vitamin B group) for accelerating electron migration (an oxidation-reduction reaction) is desirably added to the saccharides etc. having the group in which a polarization between the oxygen atom and the hydrogen atom is small, and the hydrogen atom is not easily dissociated, for example, the phenolic hydroxyl group and the alcoholic hydroxyl group. That is, adding the additive belonging to the vitamin B group allows life duration of the dissolved hydrogen to be prolonged. For example, upon exemplifying vitamin B3 (niacin) for explanation, as indicated below, an interaction between the niacin and the hydrogen molecule enhances stability of the hydrogen in the aqueous solution. As a result, life duration of the dissolved hydrogen is prolonged.

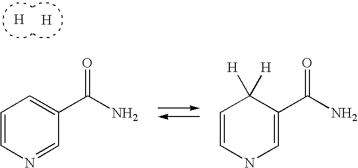

That is, employing the vitamin B group and the coenzyme that contribute to the oxidation-reduction reaction allows the hydrogen molecule to be stabilized owing to an interaction with the oxidation-reduction reaction group similarly to the case of an interaction between the niacin and the hydrogen molecule. As a result, life duration of the dissolved hydrogen is prolonged. And, additionally employing ubiquinone, ubiquinol, pyrroloquinoline quinone, etc. in which a reversible oxidation-reduction reaction is enabled contributes to stabilization of the hydrogen molecule likewise. Vitamin A, vitamin C, vitamin D, vitamin E, etc. each of which has a function of being able to supply the hydrogen atom or the hydrogen ion, and the electron also prolong life duration of the dissolved hydrogen.

The above-mentioned additives (the substance having a reducing aldehyde group and/or a hydroxyl group, the vitamin, and the coenzyme) are preferably added so that the aqueous solution has the oxidation-reduction potential of 0 mV or less.

The aqueous solution of the present invention is one having hydrogen dissolved therein. Such a hydrogen-dissolved aqueous solution could be one obtained by supplying the hydrogen gas coming from the hydrogen steel cylinder to water and dissolving it. However, preferably, it is electrolytic cathode water. Or it is an aqueous solution having hydrogen generated by a reaction between water and magnesium (magnesium alloy) dissolved therein.

### AN ADVANTAGEOUS EFFECT OF THE INVENTION

The present invention makes it possible to obtain an aqueous solution of which dissolved hydrogen has long life duration, which is said to be helpful to maintenance/promotion of health. Besides, a cost for producing it is inexpensive because the method therefore is nothing but to add only the substance having a reducing aldehyde group and/or a hydroxyl group. And, the above-mentioned additive can be obtained by employing extracts from substances existing in a state of nature, that is, only natural-origin substances are employed therefore, so no anxiety exists over the additive from a viewpoint of health.

Besides, adding not only the additive such as the saccharides but also the vitamin and the coenzyme accelerates dissociation of the hydrogen atom/hydrogen ion all the more. As a result, the aqueous solution of which the dissolved hydrogen has longer life duration can be obtained.

### BRIEF DESCRIPTION OF THE DRAWINGS

FIG. 1 is a schematic view of a two-chamber electrolysis cell.

FIG. 2 is a schematic view of a three-chamber electrolysis cell.

FIG. 3 is a block diagram of a system for generating the reductive aqueous-solution with extracts.

FIG. 4 is a block diagram of a system for electrolyzing the aqueous solution with extracts.

### BEST MODE FOR CARRYING OUT THE INVENTION

The present invention is an aqueous solution (drinking water) that is drinks for a purpose of maintaining/promoting health. This aqueous solution is an aqueous solution having hydrogen (H₂) dissolved therein at a concentration of not less than 0.01 ppm and yet not higher than a saturated concentration. In particular, it is an aqueous solution having hydrogen dissolved therein at a concentration of not less than 0.05 ppm, furthermore, not less than 0.1 ppm, and above all, not less than 0.3 ppm. While no special restraint to the upper-limit value is put, as matters now stand, it is 1.5 ppm or so. Herein, the reason why the dissolved amount of the hydrogen is defined as 0.01 ppm or more, and in particular, as 0.05 ppm or more is that an effect owing to the hydrogen is weak when the dissolved amount of the hydrogen is low. Thus, when the dissolved amount is low, it does not make sense even though life duration of the dissolved hydrogen is prolonged. The present invention is an aqueous solution having the substance having a reducing aldehyde group and/or a hydroxyl group (the hydroxyl group is a glycosidic hydroxyl group, a phenolic hydroxyl group, or an alcoholic hydroxyl group. They are enumerated in a descending order of the effect, to begin with the first one) added hereto. The contained amount of the above substance is 10 ppm to 300,000 ppm. It is, in particular, 50 ppm or more, and furthermore, 100 ppm or more. Herein, the reason why the contained amount of the above substance is defined as 10 ppm or more is that an effect of extending life duration of the dissolved hydrogen is weak when the contained amount is too low, i.e. less than 10 ppm. No special restraint to the upper-limit value is put. However, as matters now stand, it is 150,000 ppm or less. Furthermore, it is 100,000 ppm or less.

As mentioned above, if the hydrogen-dissolved aqueous solution is preserved in a sealed vessel, long life duration of the dissolved hydrogen is not lost even though it is preserved for a long time. Thus, even though the hydrogen-dissolved aqueous solution is picked up from the vessel preserved for a long time, the hydrogen is abundantly included therein. Thus, intake thereof into a human body remarkably accelerates an effect of health owing to the dissolved hydrogen.

Further, the present invention is a method for prolonging life duration of the dissolved hydrogen in the aqueous solution having the hydrogen dissolved therein. In particular, the present invention is a method for prolonging life duration of the dissolved hydrogen in the aqueous solution having the hydrogen dissolved therein at the above-mentioned concentration. The present invention includes a process of adding the substance having a reducing aldehyde group and/or a hydroxyl group (the hydroxyl group is a glycosidic hydroxyl group, a phenolic hydroxyl group, or an alcoholic hydroxyl group. They are enumerated in a descending order of the effect, to begin with the first one) at the above-mentioned concentration. Preferably, it includes a process of adding the vitamin and/or the coenzyme additionally.

Further, the present invention is a method for producing drinking water having hydrogen dissolved therein at a concentration of not less than 0.01 ppm and yet not higher than a saturated concentration. In particular, the present invention is a method for producing drinking water of which the dissolved hydrogen has long life duration. The present invention includes a process of adding the substance having a reducing aldehyde group and/or a hydroxyl group (the hydroxyl group is a glycosidic hydroxyl group, a phenolic hydroxyl group, or an alcoholic hydroxyl group. They are enumerated in a descending order of the effect, to begin with the first one) at the above-mentioned concentration. Preferably, it includes a process of adding the vitamin and/or the coenzyme additionally.

The substance having a reducing aldehyde group and/or a hydroxyl group is a cell-extract. Specifically, it is a cell-extract that is extracted, for example, from the tea such as green tea, barley tea, black tea, oolong tea, eucommia ulmoides tea, seaweed drink, and hub tea, etc. Or, it is a cell-extract that is extracted from yeast extract, honey, ginseng, panax ginseng, maca, sesame, honey sugar (for example, sugarcane, beet, etc.), agaricus, aloe, garlic, etc. Or, it is a cell-extract that is extracted from fruit or vegetable. For example, it is juice (squeezed juice) of orange, grape fruit, grape, apple, pineapple, mango, tomato, melon, Ume, carrot, onion, celery, cabbage, etc. The above-mentioned cell-extract is, for example, saccharides, or salts thereof. Upon explaining it more specifically, for example, it is monosaccharides, disaccharides, oligosaccharides, polysaccharides, sugar alcohol, etc. As monosaccharides, for example, there can be listed glucose, galactose, mannose, fructose, ribose, allose, gulose, xylose, arabinose, lyxose, idose, talose, etc. As disaccharides, there can be listed, for example, maltose, lactose, cellobiose, fructose, etc. As oligosaccharides, there can be listed, for example, oligosaccharide, etc. As polysaccharides, there can be listed, for example, chitin, chitosan, starch, cellulose, carrageenan, glycogen, pectin, dextrin, xyloglucan, gelatin, hyaluronic acid, alginic acid, etc. Further, Na-salts and K-salts of the foregoing compounds are also employed. Additionally, the monosaccharide, of which a molecular weight is smaller, is more preferable than the polysaccharides. The above-mentioned cell-extract is, for example, polyphenol. Upon explaining it more specifically, there can be listed, for example, flavonoid (catechin, anthocyanin, tannin, rutin, isoflavone, etc.), anthocyanin, phenolic acid (chlorogenic acid, ellagic acid, lignan, curcumin, coumarin, etc.), ellagic acid, lignan, curcumin, coumarin, etc.

In the present invention, at least the substance having a reducing aldehyde group and/or a hydroxyl group is added. Preferably, the vitamin (for example, vitamin A, a vitamin B group, vitamin C (for example, ascorbic acid), vitamin D, niacin, and vitamin E) is added additionally. Above all, vitamin C (ascorbic acid), vitamin B2, niacin, and vitamin E are particularly effective. The reason is that they contribute to oxidation/reduction. Further, preferably, the coenzyme (for example, vitamin B2, niacin, vitamin C, vitamin E, ubiquinone, ubiquinol, pyrroloquinoline quinone, etc.) is added. That is, combining the vitamin, being a substance for accelerating an oxidation/reduction reaction, or the coenzyme therewith exhibits a desirable result. That is, additionally employing the vitamin or the coenzyme makes it possible to prolong life duration of the ORP of which the value is 0 or less. For example, vitamin C has two hydrogen atoms (hydrogen ion and an electron), and these hydrogen atoms, which are dissociated, contribute to strong reducing ability. Vitamin E as well is a strong reducing agent with an extent at which three-valence Fe ion is reduced into two-valence Fe ion. On the other hand, vitamin B2 and niacin of the vitamin B group in which the oxidation-reduction reaction is reversible and dissociation of the hydrogen atom (the hydrogen ion and the electron) is reversible is known to be of electron-transfer system. And, increasing a concentration of the hydrogen ion and the electron allows an enhancement in the dissolved hydrogen concentration to be realized. And yet, it makes it possible to extend life duration of the dissolved hydrogen (life duration of the ORP value of 0 or less). That is, these additives additionally accelerates dissociation of H, thereby prolonging life duration of the dissolved hydrogen.

The above-mentioned additives (the substance having a reducing aldehyde group and/or a hydroxyl group, the vitamin, and the coenzyme) are preferably added so that the aqueous solution has the oxidation-reduction potential of 0 mV or less versus an Ag/AgCl reference electrode.

The aqueous solution of the present invention is a solution having hydrogen dissolved therein. As a technique of obtaining such a hydrogen-dissolved aqueous solution, there exist various techniques. For example, the technique of supplying the hydrogen gas coming from a hydrogen steel cylinder to water and dissolving it is acceptable. However, electrolytic cathode water by electrolysis is preferably employed. Or, the aqueous solution with hydrogen generated by using a corrosion reaction of magnesium and/or magnesium alloy and water dissolved therein is preferably employed. The aqueous solution of the present invention is obtained with various techniques. For example, the technique exists of supplying the hydrogen gas coming from a steel cylinder to the aqueous solution pre-containing the cell-extract and dissolving it in the aqueous solution. Or, the technique exists of dissolving the hydrogen gas generated with the cathodic electrolysis of water in the aqueous solution containing the cell-extract. Or, the technique exists of adding the cell-extract to the water having the hydrogen gas generated with the cathodic electrolysis dissolved therein. As a technique of dissolving the hydrogen gas, there exist various techniques. For example, the technique exists of bubbling the hydrogen gas, thereby to dissolve it. Or, the technique exists of dissolving the hydrogen gas via a filter. It is effective to employ the filter so as to dissolve the hydrogen gas in a large amount of the solution with extracts. This method is effective also in the case of dissolving the hydrogen gas generated with the cathodic electrolysis of water in the solution with extracts. The following technique is thinkable as a technique of mixing the aqueous solution containing the cell-extract and the cathodic electrolytic solution. For example, the technique exists of mixing the cathodic electrolytic solution and the aqueous solution containing the cell-extract. Or, the technique exists of employing the pure water and the aqueous solution containing the cell-extract mixed therein as a raw solution that is supplied to a cathode chamber.

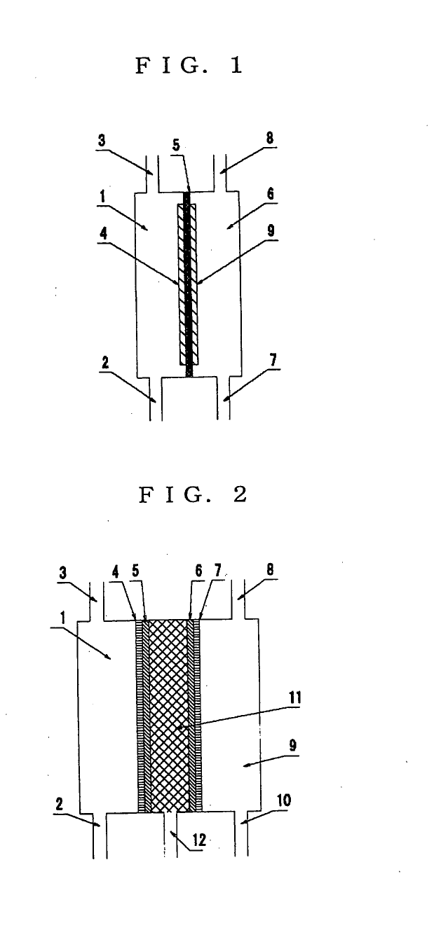

Next, how to directly increase the dissolved hydrogen concentration of the water or the solution with extracts will be explained. The present invention has an object of increasing the dissolved hydrogen concentration without largely changing solution characteristics of the aqueous solution with extracts such as pH. Further, an object of the present invention is to gain the ORP value less than zero (reducing region). For this purpose, an electrolysis device (electrolysis cell) that can electrolyze pure water without addition of a large amount of electrolytes is preferably employed. As such an electrolysis cell, a two-chamber or a three-chamber electrolysis cell can be listed. A structure of the two-chamber electrolysis cell is shown in FIG. 1. A structure of the three-chamber electrolysis cell is shown in FIG. 2. In FIG. 1, a porous electrode and an ion exchange membrane are preferably arranged to closely stick to each other. A fluorine-based cation exchange membrane is suitable as a membrane so as to electrolyze pure water. Also in the three-chamber electrolysis cell shown in FIG. 2, the porous electrode and the fluorine-based ion-exchange membrane are employed, and ion-exchange resin is filled into an intermediate chamber. Employing such an electrolysis cell structure enables pure water to be electrolyzed at a low voltage. Additionally, in FIG. 1, 1 is an anode chamber, 2 is an inlet of the anode chamber, 3 is an exit of the anode chamber, 4 is an anode electrode, 5 is a membrane, 6 is a cathode chamber, 7 is an inlet of the cathode chamber, 8 is an exit of the cathode chamber, and 9 is a cathode electrode. In FIG. 2, 1 is an anode chamber, 2 is an inlet of the anode chamber, 3 is an exit of the anode chamber, 4 is a porous anode electrode, 5 is a porous membrane, is a membrane, 7 is a cathode electrode, 8 is an exit of the cathode chamber, 9 is a cathode chamber, 10 is an inlet of the cathode chamber, 11 is a electrolyte supplying chamber, and 12 is an inlet of the electrolyte supplying chamber.

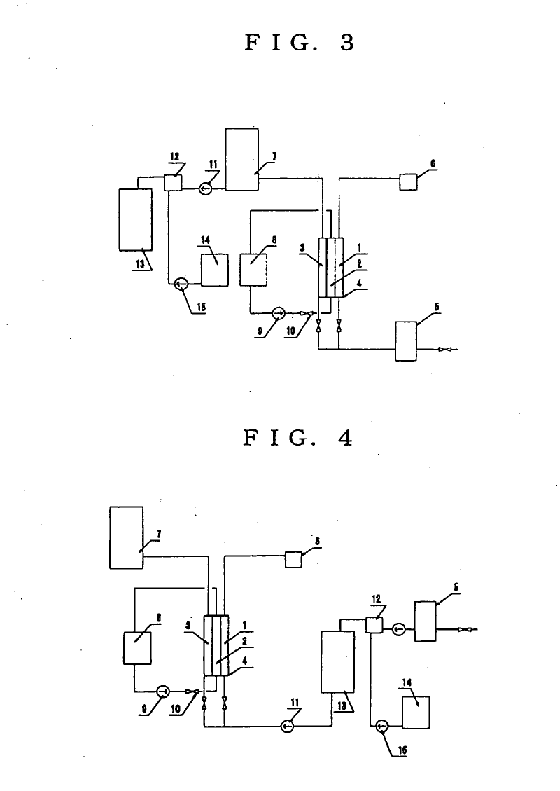

Next, a system for generating the aqueous solution of the present invention will be briefly explained. Each of FIG. 3 and FIG. 4 is a block diagram of the generating system. FIG. 3 is a block diagram of a system for generating the reductive aqueous-solution with extracts. In FIG. 3, 1 is an anode chamber, 2 is an intermediate chamber, 3 is a cathode chamber, 4 is a three-chamber electrolysis cell, 5 is a pure water generator, 6 is an anodic electrolytic solution tank, 7 is a cathodic electrolytic solution tank, 8 is an electrolyte solution tank, 9 is a pump, 10 is a flow regulatory valve, 11 is a cathode chamber solution supplying pump, 12 is a concentration adjusting tank, 13 is a storage tank, 14 is a storage tank of solution with extracts, and 15 is a supplying pump of solutions with extracts. FIG. 4 is a block diagram of a system for electrolyzing the aqueous solution with extracts. In FIG. 4, 1 is a cathode chamber, 2 is an intermediate chamber, 3 is an a anode chamber, 4 is a three-chamber electrolysis cell, 5 is a pure water generator, 6 is an anodic electrolytic solution tank, 7 is a storage tank, 8 is an intermediate chamber electrolyte solution tank, 9 is a pump, 10 is a flow regulatory valve, 11 is a cathode chamber solution supplying pump, 12 is a concentration adjusting tank, 13 is a storage tank of the aqueous solution with extracts, 14 is a storage tank of the solution with extracts, and 15 is a supplying pump of the solutions with extracts.

Hereinafter, the present invention will be more specifically explained.

### Example 1

In this example, the compound (the cell-extract) having a reducing aldehyde group (CHO group) or a hydroxyl group (OH group) was employed. That is, it is shown that adding these kinds of the cell-extracts prolonged life duration of the dissolved hydrogen.

The dissolved hydrogen concentration is evaluated with the oxidation-reduction potential (ORP). As the dissolved hydrogen concentration is increased, the ORP has a larger minus value. Thus, investigating a change with time of the ORP allows an effect of extending life duration of the dissolved hydrogen to be evaluated.

As a cell-extract, monosaccharides, disaccharides, oligosaccharides, polysaccharides, amino sugars, sugar alcohols, lactones, and polyphenol were employed. More specifically, as shown in table 1, D-(+)-glucose, sucrose, oligosaccharide, starch, carboxymethylcellulose, chondroitin sulfate, glycerin, sorbitol, vitamin C, and gallic acid were employed.

The three-chamber electrolysis cell shown in FIG. 2 was employed for supplying the hydrogen. Additionally, Nafion NR50 (fluorine-based cation exchange resin; produced by DuPont) was filled into the intermediate chamber, and Nafion 117 was employed as a membrane. An area of the porous electrode that closely sticks to the membrane is 80 mm×60 mm. And, an electric current of 3 A was allowed to flow. Pure water was supplied to the intermediate chamber, the cathode chamber, and the anode chamber. The electrolytic cathode water (dissolved hydrogen concentration: 0.8 ppm) obtained in such a manner was employed as a hydrogen-dissolved aqueous solution.

Next, a change with time of the ORP in the case of dissolving the cell-extract of 0.5 g in the electrolytic cathode water of 200 ml is shown in Table-1.

TABLE 1

| | ORP (mV) | | | |
|---|---|---|---|---|
| | Immediately | | | |
| | after | After | After | After |
| Cell-extract | addition | 2 hours | 4 hours | 24 hours |
| No addition | −422 | 273 | 367 | 422 |
| Glucose (monosaccharide) | −448 | −448 | −425 | 212 |
| Sucrose (disaccharides) | −441 | −320 | −444 | 213 |
| Oligosaccharide | −441 | −431 | −410 | 312 |
| (oligosaccharides) | | | | |
| CMC (polysaccharides) | −558 | −549 | −525 | 92 |
| Starch (polysaccharides) | −619 | −464 | — | 352 |
| Chondroitin sulfate | −562 | −558 | −524 | −89 |
| (amino sugar) | | | | |
| Glycerin (sugar alcohol) | −438 | −444 | −410 | 314 |
| Sorbitol (sugar alcohol) | −448 | −449 | −443 | 196 |
| vitamin C (lactones) | −381 | −365 | −345 | 154 |
| Gallic acid (polyphenol) | −368 | −366 | 167 | 397 |

It can be seen from Table-1 that adding these kinds of the cell-extracts extends life duration that the ORP value is in a state of being minus. That is, it can be seen that adding these kinds of the cell-extracts prolongs life duration of the dissolved hydrogen.

### Example 2

In this example, vitamin B2 having a flavin structure relating to an electron-transfer system or an oxidation-reduction reaction was employed as an additive additionally. That is, vitamin B2 of 0.1 g was additionally added in each of the cases of the example 1. A change with time of the ORP in this case is shown in Table-2.

TABLE 2

| | ORP (mV) | | | |
|---|---|---|---|---|
| | Immediately | | | |
| | after | After | After | After |
| Cell-extract | addition | 2 hours | 4 hours | 24 hours |
| No addition | −422 | 273 | 367 | 422 |
| Glucose (monosaccharides) | −472 | −499 | −502 | −449 |
| Sucrose (disaccharides) | −473 | −500 | −494 | −454 |
| Oligosaccharide | −446 | −477 | −460 | −350 |
| (oligosaccharides) | | | | |
| CMC (polysaccharides) | −474 | −554 | −544 | 165 |
| Starch (polysaccharides) | −470 | −485 | −475 | 355 |
| Glycerin (sugar alcohol) | −436 | −431 | −463 | 200 |
| Sorbitol (sugar alcohol) | −447 | −480 | −475 | −447 |
| Gallic acid (polyphenol) | −399 | −376 | −362 | 378 |
| Tannic acid (polyphenol) | −460 | −451 | −444 | 382 |

It can be seen from Table-2 that employing vitamin B2 together with the cell-extract extends life duration that the ORP value is in a state of being minus. That is, it can be seen that employing vitamin B2 together therewith prolongs life duration of the dissolved hydrogen all the more.

### Example 3

In this example, an effect of promoting an extension of life duration of the dissolved hydrogen by vitamin B3 (niacin) taking part in the oxidation-reduction reaction in a living body was investigated. That is, vitamin B3 of 0.5 g was additionally added in each of the cases of the example 1. A change with time of the ORP in this case is shown in Table-3.

TABLE 3

| | ORP (mV) | | | |
|---|---|---|---|---|
| | Immediately | | | |
| | after | After | After | After |
| Cell-extract | addition | 2 hours | 4 hours | 24 hours |
| No addition | −422 | 273 | 367 | 422 |
| Glucose (monosaccharides) | −515 | −541 | −540 | −470 |
| Sucrose (disaccharides) | −512 | −500 | −505 | −310 |
| Oligosaccharide | −502 | −506 | −490 | −130 |
| (oligosaccharides) | | | | |
| CMC (polysaccharides) | −584 | −549 | −553 | −52 |
| Starch (polysaccharides) | −515 | −485 | −511 | 28 |
| Chondroitin sulfate | — | −570 | −562 | −80 |
| (amino sugar) | | | | |
| Glycerin (sugar alcohol) | −527 | −531 | −523 | −127 |
| Sorbitol (sugar alcohol) | −490 | −500 | −501 | −129 |
| Gallic acid (polyphenol) | −398 | −407 | −390 | 277 |
| Tannic acid (polyphenol) | −481 | −521 | −472 | −298 |

It can be seen from Table-3 that employing vitamin B3 together with the cell-extract extends life duration that the ORP value is in a state of being minus. That is, it can be seen that employing vitamin B3 together therewith prolongs life duration of the dissolved hydrogen all the more.

### Example 4

In this example, an effect of promoting an extension of life duration of the dissolved hydrogen by vitamin C was investigated. That is, vitamin C of 0.1 g was additionally added in each of the cases of the example 1. A change with time of the ORP in this case is shown in Table-4.

TABLE 4

| | ORP (mV) | | | |
|---|---|---|---|---|
| | Immediately | | | |
| | after | After | After | After |
| Cell-extract | addition | 2 hours | 4 hours | 24 hours |
| No addition | −422 | 273 | 367 | 422 |
| Glucose (monosaccharides) | −475 | −377 | −355 | −230 |
| Sucrose (disaccharides) | −412 | −346 | −375 | −304 |
| Oligosaccharide | −377 | −355 | −334 | 140 |
| (oligosaccharides) | | | | |
| CMC (polysaccharides) | −535 | −385 | −416 | −419 |
| Starch (ploysaccharides) | −366 | −383 | −377 | −355 |
| Chondroitin sulfate | — | −388 | −407 | −359 |
| (amino sugar) | | | | |
| Glycerin (sugar alcohol) | −375 | −372 | −368 | −290 |
| Sorbitol (sugar alcohol) | −378 | −349 | −335 | 161 |
| Tannic acid (polyphenol) | −376 | −372 | −362 | −335 |

It can be seen from Table-4 that employing vitamin C together with the cell-extracts extends life duration that the ORP value is in a state of being minus. That is, it can be seen that employing vitamin C together therewith prolongs life duration of the dissolved hydrogen all the more.

### Example 5

In this example, an effect of promoting an extension of life duration of the dissolved hydrogen by vitamin E was investigated. That is, vitamin E of 0.1 g was additionally added in each of the cases of the example 1. A change with time of the ORP in this case is shown in Table-5.

TABLE 5

| | ORP (mV) | | | |
|---|---|---|---|---|
| | Immediately | | | |
| | after | After | After | After |
| Cell-extract | addition | 2 hours | 4 hours | 24 hours |
| No addition | −422 | 273 | 367 | 422 |
| Glucose (monosaccharides) | −475 | −440 | −434 | −240 |
| Sucrose (disaccharides) | −412 | −420 | −425 | 168 |
| Oligosaccharide | −442 | −433 | −413 | 295 |
| (oligosaccharides) | | | | |
| CMC (polysaccharides) | −550 | −530 | −508 | 64 |
| Chondroitin sulfate | — | −568 | −536 | −370 |
| (amino sugar) | | | | |
| Sorbitol (sugar alcohol) | −615 | −600 | −596 | 96 |
| Gallic acid (polyphenol) | −436 | −376 | −429 | 315 |
| Tannic acid (polyphenol) | −447 | −440 | −435 | 255 |

It can be seen from Table-5 that employing vitamin E together with the cell-extracts extends life duration that the ORP value is in a state of being minus. That is, it can be seen that employing vitamin E together therewith prolongs life duration of the dissolved hydrogen all the more.

### Example 6

This example is an example of employing the cell-extract extracted from plant etc. The supplied substance is honey, honey sugar, seaweed drink, barley tea, green tea, brown rice tea, roasted tea, and black tea. That is, the honey, the honey sugar, and the seaweed drink were poured by an amount of 1 g into the electrolytic cathode water of 200 ml employed in the example 1, respectively. Further, one commercially available pack of each of the barley tea, the green tea, the brown rice tea, the roasted tea, and the black tea was steeped in it. A change with time of the ORP in this case is shown in Table-6.

TABLE 6

| | ORP (mV) | | | |
|---|---|---|---|---|
| | Immediately | | | |
| | after | After | After | After |
| Cell-extract | addition | 2 hours | 5 hours | 24 hours |
| No addition | −422 | 273 | — | 422 |
| Honey | −450 | −440 | −300 | −148 |
| Honey sugar | −465 | −450 | −224 | −220 |
| Seaweed drink | −464 | −468 | −401 | −256 |
| Barley tea | −447 | −308 | −139 | −200 |
| Green tea | −516 | −433 | −256 | −436 |
| Brown rice tea | −518 | −413 | −274 | −434 |
| Roasted tea | −518 | −412 | −387 | −150 |
| Black tea | −484 | −350 | −435 | −202 |

It can be seen from Table-6 that adding these kinds of the cell-extracts extends life duration that the ORP value is in a state of being minus. That is, it can be seen that adding these kinds of the cell-extracts prolongs life duration of the dissolved hydrogen.

### Example 7

This example is an example of employing juices and milk as a cell-extract. As juices, an orange juice, an apple juice, a grape juice, a tomato juice, a vegetable (carrot, tomato, and celery) mixed juice were employed. That is, each juice of 50 ml was added to the electrolytic cathode water of 150 ml employed in the example 1. With regard to milk, condensed milk for coffee of 50 ml was added to the electrolytic cathode water of 200 ml employed in the example 1. A change with time of the ORP in this case is shown in Table-7.

TABLE 7

| | ORP (mV) | | | |
|---|---|---|---|---|
| | Immediately | | | |
| | after | After | After | After |
| Cell-extract | addition | 2 hours | 4 hours | 24 hours |
| No addition | −422 | 273 | 367 | 422 |
| Orange juice | −389 | −253 | −295 | −231 |
| Apple juice | −401 | −253 | −244 | −356 |
| Grape juice | −386 | −357 | −398 | −236 |
| Tomato juice | −412 | −410 | −416 | −265 |
| Vegetable juice | −435 | −411 | −408 | −355 |
| Milk | −623 | −616 | −576 | 167 |

It can be seen from Table-7 that adding these kinds of the cell-extracts extends life duration that the ORP value is in a state of being minus. That is, it can be seen that adding these kinds of the cell-extracts prolongs life duration of the dissolved hydrogen.

### Example 8

This example is an example of employing panax ginseng, ginseng, maca, ginkgo, garlic, and sesame as a raw material of the cell-extract. That is, each above-mentioned raw material of 1 g was added to the electrolytic cathode water of 200 ml employed in the example 1. A change with time of the ORP in this case is shown in Table-8.

TABLE 8

| | ORP (mV) | | | |
|---|---|---|---|---|
| | Immediately | | | |
| | after | After | After | After |
| Cell-extract | addition | 2 hours | 4 hours | 24 hours |
| No addition | −422 | 273 | 367 | 422 |
| Panax ginseng | −435 | −407 | −360 | −355 |
| Ginseng | −412 | −357 | −358 | −265 |
| Maca | −389 | −355 | −295 | −231 |
| Ginkgo | −401 | −361 | −386 | −356 |
| Garlic | −386 | −331 | −361 | −236 |
| Sesame | −364 | −337 | −350 | −205 |

It can be seen from Table-8 that adding these kinds of the cell-extracts extends life duration that the ORP value is in a state of being minus. That is, it can be seen that adding these kinds of the cell-extracts prolongs life duration of the dissolved hydrogen.

### Example 9

A difference of the method of supplying hydrogen was investigated in this example.

As a method of dissolving hydrogen, (1) the method of dissolving hydrogen being supplied from a hydrogen gas steel cylinder, (2) the method of employing the electrolytic water, and (3) the method of dissolving hydrogen cathode generated with a progress in corrosion of magnesium etc. are thinkable.

Thereupon, the hydrogen-dissolved aqueous solutions by the above-mentioned techniques (the dissolved hydrogen concentration in the case of the hydrogen coming from a gas steel cylinder: 0.7 ppm, the dissolved hydrogen concentration of the electrolytic cathode water: 0.8 ppm, and the dissolved hydrogen concentration in the case of employing magnesium: 0.65 ppm) were employed. A change with time of the ORP in this case is shown in Table-9.

TABLE 9

| | | ORP (mV) | | | |
|---|---|---|---|---|---|
| | | Immediately | | | |
| | | after | After | After | After |
| Cell-extract | Water | addition | 2 hours | 4 hours | 24 hours |
| No addition | Electrolytic | −422 | 273 | 367 | 422 |
| | cathode | | | | |
| | water | | | | |
| Glucose | Electrolytic | −448 | −448 | −425 | 212 |
| | cathode | | | | |
| | water | | | | |
| No addition | Gas steel | −452 | 125 | 320 | 356 |
| | cylinder | | | | |
| | water | | | | |
| Glucose | Gas steel | −463 | −453 | −412 | 256 |
| | cylinder | | | | |
| | water | | | | |
| No addition | Magnesium | −398 | 250 | 384 | 375 |
| | water | | | | |
| Glucose | Magnesium | −401 | −384 | −352 | 295 |
| | water | | | | |

It can be seen from this that adding the cell-extract prolongs life duration of the dissolved hydrogen in any of the methods of supplying the hydrogen.

### Example 10

This example is an example of pouring the electrolytic cathode water of the example 1, the cell-extract, and the niacin into a PET bottle of 500 ml.

That is, the foregoing aqueous solution was filled into the PET bottle, which was corked and was left as it was for a predetermined time. Thereafter, the PET bottle was uncorked to take out the aqueous solution, and the ORP was measured. Its result is shown in Table-10.

TABLE 10

| | ORP (mV) | | | | |
|---|---|---|---|---|---|
| | Immediately | After | After | After | |
| | after | 30 | 1 | 3 | After |
| Cell-extract | addition | minutes | month | months | 6 months |
| No addition | −422 | 359 | 326 | 384 | 372 |
| Glucose | −515 | −514 | −400 | −350 | −300 |
| Sucrose | −512 | −507 | −300 | −280 | −250 |
| Oligosaccharide | −502 | −500 | −120 | −100 | −80 |
| CMC | −584 | −560 | −50 | −40 | −30 |

It can be seen from Table-10 that adding the above-mentioned cell-extracts prolongs life duration of the dissolved hydrogen.

Further, an effect of extending life duration of the dissolved hydrogen was confirmed with regard to, for example, galactose, mannose, fructose, ribose, allose, gulose, xylose, arabinose, lyxose, idose, talose, maltose, lactose, cellobiose, fructose, oligosaccharide, chitin, chitosan, carrageenan, glycogen, pectin, dextrin, xyloglucan, gelatin, hyaluronic acid and alginic acid, and furthermore, Na-salts and K-salts of the foregoing acid, flavonoid, anthocyanin, phenolic acid, ellagic acid, lignan, curcumin, coumarin, etc. in addition to the above-mentioned glucose, sucrose, oligosaccharide, starch, CMC (carboxymethylcellulose), chondroitin sulfate, glycerin, sorbitol, vitamin C, tannic acid, and gallic acid.

Further, an effect was confirmed of extending life duration of the dissolved hydrogen by employing not only the above-mentioned vitamin B2, vitamin B3, vitamin C, and vitamin E, but also the vitamins such as vitamin A and vitamin D, and the coenzymes such as ubiquinone, ubiquinol, and pyrroloquinoline quinone together with these cell-extracts. Additionally, these vitamins and coenzymes were preferably added at a ratio of 1 to 10 moles over 100 moles, being an amount of this substance.

### HOW THE INVENTION IS CAPABLE OF INDUSTRIAL EXPLOITATION

The present invention is effectively employed for maintenance/promotion of health.

1.-23. (canceled)

24. Drinking water of which life duration of dissolved hydrogen is not less than one month:
wherein said drinking water is an aqueous solution, said aqueous solution produced so that hydrogen generated with cathodic electrolysis and a substance having a reducing hydroxyl group are contained in water;
wherein a contained amount of said hydrogen is not less than 0.1 ppm and yet is not higher than a saturated concentration;
wherein an electrolysis cell having a structure in which an anode chamber and a cathode chamber are separated by using a fluorine-based cation exchange membrane as a membrane, and each of an anode electrode and a cathode electrode is caused to closely stick to the fluorine-based cation exchange membrane, being a membrane, is employed for said cathodic electrolysis;
wherein a contained amount of said substance having a reducing hydroxyl group is a ratio of 100 to 150,000 ppm;
wherein said substance having a reducing hydroxyl group is a cell-extraction component; and
wherein said drinking water is filled within a vessel sealed with a lid.

25. The drinking water as claimed in claim 24, wherein a three-chamber electrolysis cell in which an intermediate chamber is provided between the anode chamber and the cathode chamber by employing a pair of the membranes, and each of the anode electrode and the cathode electrode is caused to closely stick to the fluorine-based cation exchange membrane, being a membrane, is employed.

26. The drinking water as claimed in claim 24, wherein a solution obtained by subjecting pure water to the cathodic electrolysis and a cell-extraction component solution are mixed.

27. The drinking water as claimed in claim 24, wherein a cell-extraction component aqueous solution is subjected to the cathodic electrolysis.

28. The drinking water as claimed in claim 24, wherein said substance having a reducing hydroxyl group is at least one selected from the group consisting of glucose, galactose, mannose, fructose, ribose, allose, gulose, xylose, arabinose, lyxose, idose, and talose as monosaccharides out of saccharides.

29. The drinking water as claimed in claim 24, wherein said substance having a reducing hydroxyl group is at least one selected from the group consisting of oligosaccharide, sucrose, lactose, cellobiose, maltose as disaccharides or oligosaccharides out of saccharides.

30. The drinking water as claimed in claim 24, wherein said substance having a reducing hydroxyl group is at least one selected from the group consisting of starch, carrageenan, cellulose, dextrin, xyloglucan, alginic acid, gelatin, glycogen, hyaluronic acid, and Na-salts and K-salts thereof as polysaccharides out of saccharides.

31. The drinking water as claimed in claim 24, wherein said substance having a reducing hydroxyl group is at least one selected from the group consisting of flavonoid, anthocyanin, phenolic acid, chlorogenic acid, ellagic acid, lignan, curcumin, and coumarin out of polyphenols.

32. The drinking water as claimed in claim 24, wherein said substance having a reducing hydroxyl group is at least one selected from the group consisting green tea, black tea, roasted tea, barley tea, oolong tea, eucommia ulmoides tea, hub tea, and seaweed drink, the vegetable group consisting of garlic, ginseng, gingko, carrot, onion, celery, and cabbage, a fruit group consisting of orange, grape fruit, grape, apple, pineapple, mango, tomato, melon, and ume, or the group consisting of panax ginseng, maca, sesame, honey sugar, agaricus, and aloe as plant from which the component having a reducing hydroxyl group is extracted.

33. The drinking water as claimed in claim 24, wherein ascorbic acid, vitamin B2 and vitamin B3 are additionally added to the substance having a reducing hydroxyl group.

34. The drinking water as claimed in claim 24, wherein coenzymes such as ubiquinone, ubiquinol, and pyrroloquinoline quinone are additionally added to the substance having a reducing hydroxyl group.

35. A method of producing drinking water of which life duration of dissolved hydrogen is not less than one month, said method comprising:
carrying out electrolysis by employing an electrolysis cell having a structure in which an anode chamber and a cathode chamber are separated by using a fluorine-based cation exchange membrane as a membrane, and each of an anode electrode and a cathode electrode is caused to closely stick to the fluorine-based cation exchange membrane, being a membrane, and obtaining electrolytic cathode water having hydrogen dissolved therein at a concentration of not less than 0.01 ppm and yet not higher than a saturated concentration;
adding a cell-extraction component having a reducing hydroxyl group to electrolytic cathode water obtained in said electrolyzing step at a ratio of 100 to 150,000 ppm; and
filling said aqueous solution including the hydrogen and the cell-extraction components in a vessel and sealing it.

36. A method of producing drinking water of which life duration of dissolved hydrogen is not less than one month, said method comprising:
dissolving a cell-extraction component having a reducing hydroxyl group in water at a ratio of 100 to 150,000 ppm;
electrolyzing said aqueous solution by employing an electrolysis cell having a structure in which an anode chamber and a cathode chamber are separated by using a fluorine-based cation exchange membrane as a membrane, and each of an anode electrode and a cathode electrode is caused to closely stick to the fluorine-based cation exchange membrane, being a membrane, and obtaining electrolytic cathode water having hydrogen dissolved therein at a concentration of not less than 0.01 ppm and yet not higher than a saturated concentration; and
filling said aqueous solution including the hydrogen and the cell-extraction components in a vessel and sealing it.

37. The method of producing drinking water as claimed in claim 35, said method comprising adding vitamin before the filling/sealing step.

38. The method of producing drinking water as claimed in claim 35, said method comprising adding coenzyme before the filling/sealing step.

39. The method of producing drinking water as claimed in claim 35, said cell-extraction component is one or two more selected from the group consisting of glucose, galactose, mannose, fructose, ribose, allose, gulose, xylose, arabinose, lyxose, idose, and talose as monosaccharides out of saccharides, said saccharides being one of the cell-extraction components having a reducing glycosidic hydroxyl group.

40. The method of producing drinking water as claimed in claim 35, said cell-extraction component is one or two more selected from the group consisting of oligosaccharide, sucrose, lactose, cellobiose, maltose as disaccharides or oligosaccharides out of saccharides, said saccharides being the cell-extraction component having a reducing hydroxyl group.

41. The method of producing drinking water as claimed in claim 35, said cell-extraction component is one or two more selected from the group consisting of starch, carrageenan, cellulose, dextrin, xyloglucan, alginic acid, gelatin, glycogen, hyaluronic acid, and Na-salts and K-salts thereof as polysaccharides out of saccharides, said saccharides being the cell-extraction component having a reducing hydroxyl group.

42. The method of producing drinking water as claimed in claim 35, said cell-extraction component is one or two more selected from the group consisting of flavonoid, anthocyanin, phenolic acid, chlorogenic acid, ellagic acid, lignan, curcumin, and coumarin out of polyphenols, said polyphenols being the cell-extraction component having a reducing hydroxyl group.

43. The method of producing drinking water as claimed in claim 35, said cell-extraction component is one or two more selected from the group consisting of green tea, black tea, roasted tea, barley tea, oolong tea, eucommia ulmoides tea, hub tea, and seaweed drink, the vegetable group consisting of garlic, ginseng, gingko, carrot, onion, celery, and cabbage, a fruit group consisting of orange, grape fruit, grape, apple, pineapple, mango, tomato, melon, and ume, or the group consisting of panax ginseng, maca, sesame, honey sugar, agaricus, and aloe as plant from which the component having a reducing hydroxyl group is extracted.

44. The method of producing drinking water as claimed in claim 36, said method comprising adding vitamin before the filling/sealing step.

45. The method of producing drinking water as claimed in claim 36, said method comprising adding coenzyme before the filling/sealing step.

46. The method of producing drinking water as claimed in claim 36, said cell-extraction component is one or two more selected from the group consisting of glucose, galactose, mannose, fructose, ribose, allose, gulose, xylose, arabinose, lyxose, idose, and talose as monosaccharides out of saccharides, said saccharides being one of the cell-extraction components having a reducing glycosidic hydroxyl group.

47. The method of producing drinking water as claimed in claim 36, said cell-extraction component is one or two more selected from the group consisting of oligosaccharide, sucrose, lactose, cellobiose, maltose as disaccharides or oligosaccharides out of saccharides, said saccharides being the cell-extraction component having a reducing hydroxyl group.

48. The method of producing drinking water as claimed in claim 36, said cell-extraction component is one or two more selected from the group consisting of starch, carrageenan, cellulose, dextrin, xyloglucan, alginic acid, gelatin, glycogen, hyaluronic acid, and Na-salts and K-salts thereof as polysaccharides out of saccharides, said saccharides being the cell-extraction component having a reducing hydroxyl group.

49. The method of producing drinking water as claimed in claim 36, said cell-extraction component is one or two more selected from the group consisting of flavonoid, anthocyanin, phenolic acid, chlorogenic acid, ellagic acid, lignan, curcumin, and coumarin out of polyphenols, said polyphenols being the cell-extraction component having a reducing hydroxyl group.

50. The method of producing drinking water as claimed in claim 36, said cell-extraction component is one or two more selected from the group consisting of green tea, black tea, roasted tea, barley tea, oolong tea, eucommia ulmoides tea, hub tea, and seaweed drink, the vegetable group consisting of garlic, ginseng, gingko, carrot, onion, celery, and cabbage, a fruit group consisting of orange, grape fruit, grape, apple, pineapple, mango, tomato, melon, and ume, or the group consisting of panax ginseng, maca, sesame, honey sugar, agaricus, and aloe as plant from which the component having a reducing hydroxyl group is extracted.
